(19) United States
(12) Patent Application Publication
(10) Pub. No.: US 2009/0132394 A1
(43) Pub. Date: May 21, 2009

(54) Delivering Product Impact Information At The Point Of Sale

(76) Inventor: Gosakan Aravamudan, Bangalore (IN)

Correspondence Address: Ashok Tankha, 36 Greenleigh Drive, Sewell, NJ, 08080, US

(21) Appl. No.: 12/137,551

(22) Filed: Jun. 12, 2008

(30) Foreign Application Priority Data
Nov. 15, 2007 (IN) 1248/CHE/2007

(51) Int. Cl. G06Q 99/00

(52) U.S. Cl. 705/30

(57) ABSTRACT

Disclosed herein is a method and system for providing a consumer with information on lifecycle of a product at the point of sale. The product lifecycle information comprises lifecycle assessment data on the product with a specific focus on social, environmental, and energy impact attributes of the product. The product lifecycle comprises product creation, product usage, waste disposal, and product disposal. A lifecycle assessment entity is provided to deliver information on the product lifecycle. Information related to the lifecycle of the product is captured automatically and stored in a product information bank. The consumer requests for lifecycle information on a particular product and the requested lifecycle information pertaining to the product is retrieved from the product information bank and delivered to the consumer.

### CROSS REFERENCE TO RELATED APPLICATIONS

This application claims the benefit of the Indian patent application 1248/CHE/2007 titled “Delivering Product Impact Information At The Point Of Sale” filed on Jun. 15, 2007 in the Indian Patent Office.

### BACKGROUND

This invention, in general, relates to delivery of product information to consumers and more specifically relates to delivery of product information related to social, energy and environmental impact to consumers at the point of sale.

In the current arts, the product information provided to a consumer typically comprises the date of manufacture, product composition, expiry date, etc. The product information is usually provided on a label affixed to a product, or on the product's package. Consumers typically rely on brand names of the products, manual examination of the products at the time of purchase, etc., to decide on the quality of the product. In such cases, limited product information is available to the consumer to make a prudent choice.

The processes involved in product manufacturing may be hazardous to the environment. Raw materials used in product manufacturing may be acquired from unreliable sources. There may be contamination and adulteration of the raw materials and hence substandard products may be manufactured. The usage and subsequent disposal of certain products may have a detrimental effect on the environment. Consumer products may not be thoroughly checked for compliance with guidelines laid down by governing bodies or institutions.

The lifecycle of a product may comprise product creation or manufacturing, product usage, waste disposal, and product disposal. Comprehensive information on above stages in a product's lifecycle is currently unavailable to the consumers at the point of sale. Consumers are being increasingly concerned about the environmental effects and the energy consumption of the products. There is an unmet need for providing comprehensive information on the social, environmental and energy impact attributes of the product.

Comprehensive product information that comprises the lifecycle of the product, the environmental effects due to manufacturing and usage of the product, energy consumption pattern of the product, etc. are currently unavailable to consumers at the point of sale. A consumer will be relieved of doubts and speculations on product quality if product lifecycle information is provided at the time of purchase.

In view of the foregoing discussion there is a need for effectively providing product lifecycle information to the consumers, specifically covering the social and environmental impact of the product, and the energy consumption pattern of the product, at the point of sale.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses the unmet need for effectively providing product lifecycle information to a consumer, specifically covering the social and environmental impact of the product, and the energy consumption pattern of the product, at the point of sale.

The first stage in a product's lifecycle is product creation or product manufacture. The method and system disclosed herein provides information on product creation comprising detailed manufacturer information, information on raw material sourcing and processing, eco-friendly methods of manufacture, energy consumption during manufacture, use of child labor during manufacturing, etc.

The second stage in the product lifecycle is the product usage. The method and system disclosed herein provides information on product usage comprising an estimate of total energy consumption by a product during the product usage, environmental effects caused by product usage, etc.

The third stage in the product lifecycle is waste creation during product usage and product manufacturing process. The method and system disclosed herein provides information on waste creation and disposal of such waste, comprising identification of wastes being generated during the product usage and environmental effects caused by waste disposal.

The fourth stage of the product lifecycle is the product disposal. The method and system disclosed herein provides information on the environmental effects due to the product disposal. For example, disposal of products composed of polythene and other similar plastic materials produce non-biodegradable plastic waste.

A lifecycle assessment entity is provided to deliver product lifecycle information to the consumer at the point of sale. The lifecycle assessment entity may be one of an apparatus in a retail shopping facility, a web portal, and a combination thereof. The retail shopping facility is a real time shopping experience for a consumer, while the web portal facilitates sale of products online over the internet. A product information bank is provided within the lifecycle assessment entity for storing the product lifecycle information. A request processor is provided within the lifecycle assessment entity for accepting requests for lifecycle information of products from a consumer via multiple input devices. The product lifecycle information is retrieved from the product information bank based on the requests. After retrieving the product lifecycle information, the product lifecycle information is delivered to the consumer via multiple output devices.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of providing product lifecycle information to a consumer at a point of sale of the product.

FIG. 2 illustrates a system for delivering product lifecycle information to a consumer at a point of sale of the product.

### DETAILED DESCRIPTION OF THE INVENTION

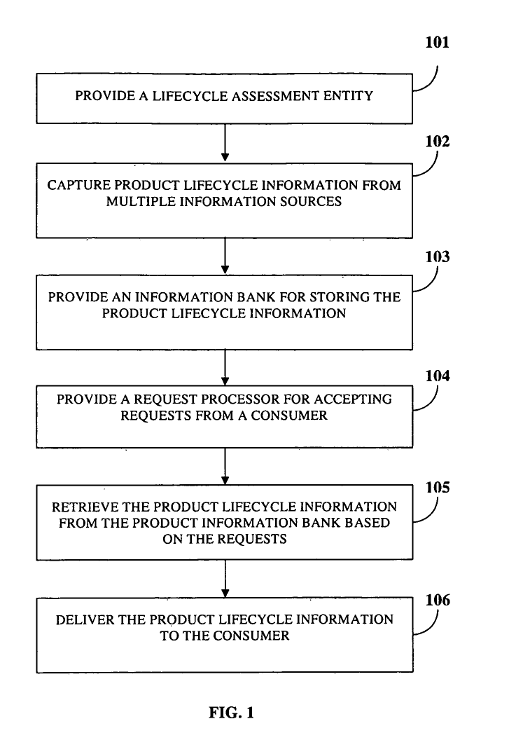

FIG. 1 illustrates a method providing a consumer 200 with information on lifecycle of a product at a point of sale of the product. As used herein, the term “product” refers to consumer products, industrial products, and services. Services may further comprise an array of services provided to individuals, institutions, and establishments. The domain or line of business of the institutions and establishments may be diverse and not similar. For example, a banking service provided to customers of a bank is considered as a product.

A lifecycle assessment entity 202 is provided 101 to deliver product lifecycle information to the consumer 200. Product lifecycle information is captured 102 from multiple information sources. The step of capturing the product lifecycle information comprises capturing product related information, in multiple stages of the product's lifecycle. Information, along the dimensions of environmental, social, and energy impact, is captured in the areas of product creation, waste creation, waste disposal, product usage, and finally product disposal. The captured product lifecycle information may comprise information on raw materials of the product, degradability of waste during waste disposal, degradability of the product during product disposal, recyclability of waste and the product, and reusability of the product. A product information bank 206 is provided 103 for storing the product lifecycle information related to multiple products. A request processor 203 is provided 104 to accept requests from the consumer 200 via multiple input devices 201. The consumer 200 generates the requests to obtain lifecycle information on products using the input devices 201. In response to the requests, the lifecycle information of the product is retrieved 105 from the product information bank 206 and delivered 106 to the consumer 200 via multiple output devices 207.

The first stage of the product lifecycle is the product creation or product manufacturing. The product creation or product manufacturing information comprises raw materials used in a product, source of the raw materials, the physical changes that the raw materials undergo during product manufacturing, apparatuses used in processing the raw materials, manufacturer information, eco-friendly methods employed during manufacturing, etc. Information pertinent to the raw materials and manufacturing methods of a product is captured automatically and delivered to the consumer 200 through the lifecycle assessment entity 202.

The second stage in the product lifecycle is the product usage. The information on the product usage comprises an estimate on total energy consumption by a product during the product usage, life of the product, environmental effects caused due to product usage, etc. The consumer 200 obtains critical information on energy consumption by a product, and based on the information delivered to the consumer 200, may attempt to use the product economically. The information on product lifespan is also delivered to the consumer 200. The information on product lifespan includes the time for which the product may be used for optimal performance and minimal waste generation.

There are several products that produce waste during their operation or usage. The information on waste creation and disposal of waste comprises identification of the wastes being generated during the product usage, and environmental effects due to disposal of the generated waste. For example, when a refrigerator is used for cooling purposes, chlorofluorocarbons are produced that deplete the ozone layer in the atmosphere. If the information on waste creation communicates the ill effects of the chlorofluorocarbons to the consumer 200, the consumer 200 may use an alternative for the refrigerant that produces chlorofluorocarbons. The final stage in the product lifecycle is the product disposal. Products may have to be disposed once the products have stopped functioning or when the products have provided service past their estimated lifespan. The product disposal information comprises biodegradability of the product, reusability of the product, and toxic effects due to product disposal.

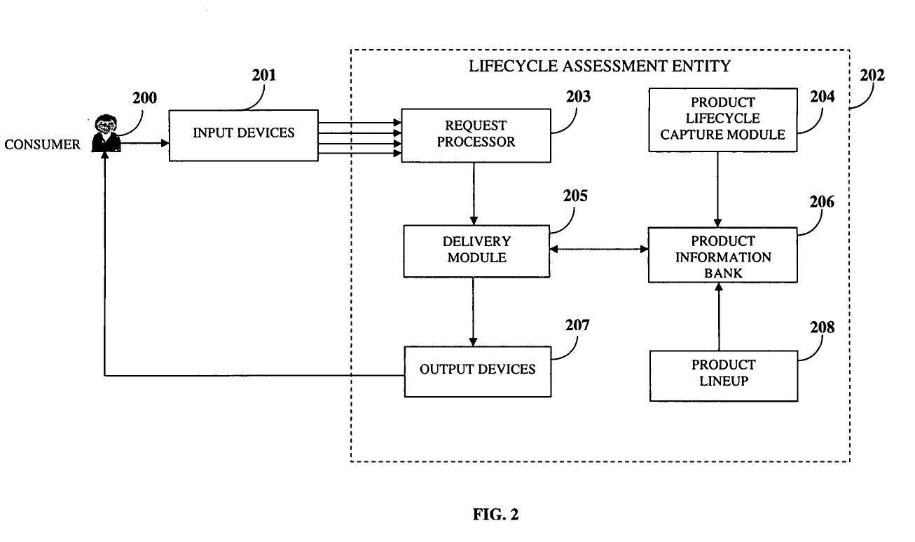

FIG. 2 illustrates a system for providing a consumer 200 with information on the lifecycle of a product at a point of sale of the product. The system disclosed herein comprises a lifecycle assessment entity 202. The lifecycle assessment entity 202 is provided to deliver information on the different stages of product lifecycle. The lifecycle assessment entity 202 may be an apparatus in a retail shopping facility. The lifecycle assessment entity 202 may be a web portal that allows the consumer 200 to purchase products online as well as receive product lifecycle information online. The lifecycle assessment entity 202 comprises a product lifecycle capture module 204, a product information bank 206, a request processor 203, and a delivery module 205. The product lifecycle capture module 204 automatically captures the product lifecycle information from multiple information sources. The captured product lifecycle information is stored in the product information bank 206. The product information bank 206 is a database for storing information on lifecycle of products.

The lifecycle assessment entity 202 may further comprise a product lineup 208. The product lineup 208 is an arrangement of products in the retail shopping facility. The consumer 200 entering the retail shopping facility is provided with detailed product lifecycle information. The consumer 200 may use multiple input devices 201 to request for product lifecycle information. The requests may be generated from the input devices 201 based on consumer's 200 preferences. The input devices 201 used by the consumer 200 to raise a request on product lifecycle information may be one of a computer, a mobile phone device, a fixed telephone, a touch screen input device, tag reader machines, etc. The request generated by the consumer 200 is input to the request processor 203. The request processor 203 accepts the requests on the product lifecycle from the consumer 200.

On accepting the requests, the request processor 203 generates a search query. The search query is used to search for the requested product lifecycle information in the product information bank 206. The search query is routed to the delivery module 205. The delivery module 205 accepts and parses the search query generated by the request processor 203. The delivery module 205 uses a search algorithm to locate and retrieve the lifecycle information of a product stored in the product information bank 206. Since one or more output devices 207 may be used by the consumer 200 to obtain the product lifecycle information, the delivery module 205 may deliver the product lifecycle information to the consumer 200 via the output devices 207. For example, the consumer 200 may access a website to raise a query on product lifecycle information and the consumer 200 may prefer a short message service on product lifecycle information to be delivered to the consumer's 200 mobile phone device.

The lifecycle assessment entity 202 may be a web portal to enable the consumer 200 to conduct shopping online. The product lineup 208 is a list of products available for sale and is provided in the form of an online catalog. The product lifecycle information is also provided to the consumer 200 online, over the internet. The web portal comprises an information processing and information retrieval structure similar to the retail shopping facility. The web portal comprises the request processor 203, the delivery module 205, and the product information bank 206. The request processor 203 is a web application that accepts request for product lifecycle information from multiple input devices 201 and generates a search query. The search query uniquely identifies a product and thus relevant lifecycle information on the product is subsequently retrieved. The search query is routed to the delivery module 205. The delivery module 205 parses the search query and retrieves the product lifecycle information from the product information bank 206. The delivery module 205 delivers the product lifecycle information to the consumer 200 via one or more output devices 207.

The output devices 207 may include all the above mentioned devices and additionally display devices such as a liquid crystal display (LCD) screen, a thin film transistor (TFT) screen or a touch screen. For example, the consumer 200 may access a website; the website may display a number of graphical icons. The graphical icons may be pictorial representations of the products and scaled in size to occupy a considerably small region on the computer screen. The graphical icons may provide reference links to a product's lifecycle information. When the consumer 200 performs a mouse click operation on a particular graphical icon, the lifecycle information of the product whose graphical icon was clicked gets displayed on the computer screen or other display device.

Another example may be a cellular phone carried by the consumer 200 being used as an input device. The consumer 200 may send a short message from the cellular phone to a predetermined number. A unique product code is sent in the form of a short message to the predetermined number. In response to the short message, the consumer 200 may obtain product lifecycle information via one of an electronic mail, a short message, and a voice response. In another method of product lifecycle information delivery to the consumer 200, products are provided with tags at the point of sale. Each tag carries a unique product code. The tag may be held in front of a tag reader machine such that the tag reader machine identifies the product based on the product code. The tag reader machine may have an embedded display unit to display a product's lifecycle information.

The lifecycle assessment entity 202 is provided to deliver social, environmental, and energy impact product lifecycle information to the consumer 200. The information and specifications of a product are therefore not limited to manufacture date, expiry date and the raw material composition in a given product. Product lifecycle information enables the consumer 200 to judge a product based on multiple factors. For example, a civil engineer may prefer environmental friendly and biodegradable construction material. The product lifecycle of a product such as eco-friendly flooring may be of interest to the civil engineer. Lifecycle information on eco friendly flooring enables the civil engineer to validate the eco friendly nature of the flooring.

Consider the example of a consumer 200, visiting a retail store that contains the apparatus. The consumer 200 may be interested in buying recycled paper. A tag is placed next to the recycled paper. The consumer 200 picks up the tag and scans the tag in a scanning machine provided in the apparatus. The product corresponding to the tag is recognized and the product information related to the item is displayed as a video on a flat panel screen to the consumer 200. The video plays information on the substrate material the recycled paper, the source of the substrate material, the environmental footprint of the purchase such as quantifying the trees saved from papermaking, information on the people who actually produce the product, any hazardous chemicals used in the product, etc. The consumer 200 is now able to make an educated decision on the purchase of the product.

It will be readily apparent that the various methods and algorithms described herein may be implemented in a computer readable medium appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A ‘processor’ means any one or more microprocessors, Central Processing Unit (CPU) devices, computing devices, microcontrollers, digital signal processors or like devices. The term ‘computer-readable medium’ refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, or JAVA. The software programs may be stored on or in one or more mediums as an object code. A computer program product comprising computer executable instructions embodied in a computer-readable medium comprises computer parsable codes for the implementation of the processes of various embodiments.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, UltraSPARC® processors, etc. that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of providing a consumer with information on lifecycle of a product at a point of sale of said product, comprising the steps of:
providing a lifecycle assessment entity for providing said product lifecycle information to said consumer;
providing a product information bank within said lifecycle assessment entity for storing the product lifecycle information;
providing a request processor within the lifecycle assessment entity for accepting requests on said product lifecycle from the consumer;
retrieving the product lifecycle information from said product information bank based on said requests; and
delivering selectively said retrieved product lifecycle information to the consumer;
whereby the product lifecycle information is provided to the consumer at said point of sale of the product.

2. The method of claim 1, further comprising a step of capturing the product lifecycle information from a plurality of information sources and storing said captured product lifecycle information in the product information bank.

3. The method of claim 2, wherein said step of capturing the product lifecycle information further comprises capturing information on one or more of product creation, product manufacture, product usage, waste disposal, and product disposal.

4. The method of claim 3, wherein said captured product lifecycle information comprises information on raw materials of the product, degradability of waste during said waste disposal, degradability of the product during said product disposal, recyclability of said waste and the product, and reusability of the product.

5. A system for providing a consumer with information on lifecycle of a product at a point of sale of said product, comprising:
a lifecycle assessment entity for providing said product lifecycle information to said consumer, wherein said lifecycle assessment entity comprises:
a product lifecycle capture module for capturing automatically the product lifecycle information from a plurality of information sources;
a product information bank for storing said captured product lifecycle information;
a request processor for accepting requests on said product lifecycle from the consumer; and
a delivery module for delivering selectively the product lifecycle information to the consumer based on said requests.

6. The system of claim 5, wherein said request processor generates a search query on accepting the requests from the consumer, wherein said delivery module parses said search query and retrieves the product lifecycle information from said product information bank.

7. The system of claim 5, wherein said request processor accepts the requests on the product lifecycle from a plurality of input devices.

8. The system of claim 7, wherein said input devices are one or more of a computer, a cellular phone, a personal digital assistant, a fixed line telephone, a tag reader, and a scanning machine.

9. The system of claim 5, wherein said delivery module delivers the product lifecycle information to the consumer via a plurality of output devices, wherein said output devices are one or more of a computer, a cellular phone, a fixed line telephone, a liquid crystal display screen, and a thin film transistor screen.

10. A computer program product comprising computer executable instructions embodied in a computer readable medium, wherein said computer program product comprises:
a first computer parsable program code for capturing information on lifecycle of a product from a plurality of information sources;
a second computer parsable program code for storing said product lifecycle information in a product information bank;
a third computer parsable program code for accepting requests for the product lifecycle information from a consumer;
a fourth computer parsable program code for generating a search query on accepting said requests from said consumer;
a fifth computer parsable program code for parsing said search query and retrieving the product lifecycle information from said product information bank; and
a sixth computer parsable program code for delivering said retrieved product lifecycle information to the consumer.
